(19) United States
(12) Patent Application Publication
(10) Pub. No.: US 2021/0180284 A1
(43) Pub. Date: Jun. 17, 2021

(54) SYSTEMS AND METHODS FOR PERIODIC MATERIAL-BASED SEISMIC ISOLATION FOR UNDERGROUND STRUCTURES

(71) Applicant: University of Houston System, Houston, TX (US)

(72) Inventors: Yi-Lung Mo, Pearland, TX (US); Fnu Witarto, Houston, TX (US)

(73) Assignee: University of Houston System, Houston, TX (US)

(21) Appl. No.: 16/074,227

(22) PCT Filed: Feb. 1, 2017
(86) PCT No.: PCT/US2017/016003

§ 371 Date: Jul. 31, 2018

Related U.S. Application Data
(60) Provisional application No. 62/289,419, filed on Feb. 1, 2016.

(51) Int. Cl. E02D 29/045; E04H 9/02; E02D 27/34

(52) U.S. Cl. CPC E02D 29/045; F16F 15/04; E02D 27/34; E04H 9/022

(57) ABSTRACT

A seismic isolation system for underground structures comprises a periodic foundation and periodic arrays of piles in the soil or periodic piles that surround the underground structure. The periodic foundation may be a foundation of periodic materials. The periodic piles can substantially reduce the incoming seismic waves from the lateral direction. The periodic piles may be vertically arranged layers of periodic materials. The combination of the periodic foundation and periodic piles can result in total isolation for the underground structure. This total isolation may be of particular interest for underground facilities, such as underground nuclear power plants and structures with basements.

### RELATED APPLICATIONS

This application claims the benefit of U.S. Provisional Patent Application No. 62/289,419 filed on Feb. 1, 2016, which is incorporated herein by reference.

### STATEMENT REGARDING FEDERALLY SPONSORED RESEARCH

This invention was made with government support under Grant No. CFA-14-6446 from the Department of Energy. The government has certain rights in the invention.

### FIELD OF THE INVENTION

This invention relates to periodic materials. More particularly, to periodic material-based seismic isolation for underground structures.

### BACKGROUND OF INVENTION

Current seismic isolation systems employing high damping rubber bearing, lead rubber bearing, and friction pendulum system are quite effective in reducing the damaging effects due to the horizontal components of the earthquake. They are not, however, generally well suited for the provision of adequate protection against the vertical components of the seismic events. The use of current isolation systems also results in large relative horizontal displacement between the foundation and the supported structure that occurs during the seismic event, thereby complicating the design.

Periodic materials and material-based seismic isolation systems, also known as periodic foundations as discussed in U.S. Pat. No. 9,139,972, are very powerful seismic isolator devices that can completely obstruct or change the pattern of the earthquake energy when the seismic waves reach the periodic foundation. Periodic foundations can greatly reduce the damaging effects of seismic waves on the superstructure and components, in both the horizontal and vertical directions, and to accomplish this without resulting in large relative horizontal displacement cited above. Periodic foundations also act as a foundation to support the weight of the superstructure. A properly designed periodic foundation can substantially diminish the incoming seismic waves resulting in the isolation of the superstructure from the high seismic input energy. The periodic foundation will work as long as the seismic waves reach periodic foundation before they propagate to the superstructure.

In order to block the seismic waves, the waves have to reach the periodic foundation before propagating to the structure. This characteristic makes periodic foundations only applicable as an open foundation that supports a building or structure. However, for underground structures, a portion of the building or structure may be below ground so the periodic foundation will not be able to protect the waves coming from the surrounding soil. Structures with high importance factor, such as, but not limited to, nuclear power plants (NPPs) and hospitals, need to be designed to withstand earthquake with minimum damage. Designing such strong structures to fulfill such requirements will be very expensive with pre-existing technology. Therefore, equipping the structures with the improved seismic protection devices discussed further herein is a better alternative that also reduces the structural cost.

### SUMMARY OF INVENTION

In one embodiment, a seismic isolation system for underground structures comprises a periodic foundation and periodic arrays of piles in the soil or periodic piles that surround the underground structure. The periodic foundation may be a foundation of periodic materials. The periodic piles have the same characteristic as the periodic foundation in that they can substantially reduce the incoming seismic waves, but particularly from the lateral direction. The periodic piles may be vertically arranged layers of periodic materials. The combination of the periodic foundation and periodic piles can result in total isolation for the underground structure. This total isolation is of special significance to underground facilities, such as underground nuclear power plants and structures with basements.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1B are illustrate the refection of waves in within the frequency band gap of periodic material and wave propagation for a frequency outside of the frequency band gap;

FIGS. 2A-2C show a cross section, top view and bottom view of an illustrative embodiment of an isolation system for underground structure;

FIG. 3 shows an illustrative embodiment of a periodic unit cell;

FIGS. 4A-4B show an illustrative configuration of a layered periodic foundation and its unit cell;

FIGS. 5A-5B show dispersion curves;

FIG. 6 shows a test setup for a 1D periodic foundation;

FIG. 7 shows acceleration responses v. time;

FIG. 8 shows dispersion curves for periodic piles;

FIGS. 9A-9B show a top view and side view of finite-unit cell pile barriers;

FIG. 10 shows area averaged FRF (z=−L/2) for the 3D models with L=10 m, L=20 m, L=30 m, L=40 m, L=50 m and the 2D model;

FIG. 11 shows a finite element mode of an underground building (e.g. SMR) with the periodic isolation system; and

FIGS. 12A-12B respectively show the LBF and UBF changing with the size of unit cells in periodic piles and with the size length of piles.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

Underground small modular reactors (SMRs) have received increasing attention, as anxiety over the safety of nuclear power plants grows after the 9/11 terrorist attacks. SMRs currently under development are designed for standardization of design, maximum use of factory prefabricated components, and minimization of field construction. A cost effective small modular reactor must accommodate a wide variety of seismic demands. The use of base seismic isolation is a very attractive strategy in meeting these seismic demands. Current seismic isolation systems under development are quite effective in reducing the damaging effects due to the horizontal components of the earthquake. They are not, however, generally well suited for the provision of adequate protection against the vertical components of the seismic events. The use of current isolation systems also results in large relative horizontal displacement between the foundation and the supported structure that occurs during the seismic event, thereby complicating the design.

Extensive discussion of periodic material-based seismic isolation systems, periodic materials, 1D, 2D, 3D periodic materials, periodic unit cells, and various parameters and examples were previously discussed in U.S. Pat. No. 9,139,972, which is fully incorporated herein by reference. It shall be understood that the prior definitions, parameters, materials, examples, or the like shall also applicable to the discussion herein. The use of periodic material-based seismic isolators (U.S. Pat. No. 9,139,972), in NPP structures can greatly reduce the damaging effects of seismic waves on the superstructure and components, in both the horizontal and vertical directions, and to accomplish this without resulting in the large relative displacement cited above. To avoid confusion, these prior periodic material-based seismic isolation systems are referred to herein as periodic foundations.

Generally, the prior periodic foundation is inspired by the phononic crystals in solid state physics, and is an array of 1D, 2D, or 3D periodic materials that are arranged to form the foundation supporting a structure. The term “phononic crystal” will be replaced herein with the term “periodic material” for clarity purposes. This manmade material can be designed to possess specific frequency band gaps. When the frequency contents of a wave fall within the range of the frequency band gaps of a periodic structure, the wave, and hence its energy, cannot propagate through the periodic structure. Similarly, the periodic foundation can be designed to cover the main frequency content of seismic waves so that the seismic energy is prevented from reaching the structure.

In order to block the seismic waves, the waves have to reach the periodic foundation before propagating to the structure. The prior periodic foundations work as long as the seismic waves reach the periodic foundation before the waves propagate to the superstructure. However, for underground structures, seismic waves can propagate from any direction. This characteristic makes the periodic foundation most effective as an open foundation. However, for underground structure, such as underground NPPs mentioned above, the periodic foundation does not surround the structure and will not be able to protect it from the seismic waves approaching laterally from the surrounding soil.

The periodic foundation discussed in U.S. Pat. No. 9,139,972 has overcome the deficiency of other current seismic isolation mechanisms (e.g. high damping rubber bearings, lead-rubber bearings, or friction pendulum bearings). The periodic foundation allows seismic protection under horizontal and vertical earthquake with no or minimum relative displacements between the building and the foundation during the earthquakes. However, the designs present in U.S. Pat. No. 9,139,972 have applicability limited to open foundation structures.

A periodic material-based seismic isolation system for underground structures (or periodic pile system herein to avoid confusion with the prior periodic foundation) is proposed herein to overcome the shortcoming of the prior periodic foundation. A periodic pile system may comprise a periodic foundation and periodic array of piles buried under the soil. Similar to the periodic foundation, the periodic array of piles also utilize the frequency band gap characteristic to block the incoming seismic waves. However, due to the arrangement of the periodic array of piles, the piles are able to block incoming seismic waves that a horizontally arranged periodic foundation may not be able to block. It should be understood that the periodic pile system is not proposed as the substitute to a periodic foundation, but rather as a complementary device to the periodic foundation for seismic isolation of underground facilities.

As in U.S. Pat. No. 9,139,972, a periodic foundation may be present in the periodic pile system. This periodic foundation may isolate a structure from incoming vertical seismic waves. However, it should be noted that U.S. Pat. No. 9,139,972 is effective for open foundation structures and is not designed for isolating seismic waves approaching a structure laterally. Additionally, for underground structures, the periodic foundation is provided at a predetermined depth below ground, which exposes the structure to lateral seismic waves.

To isolate the underground structure from incoming lateral seismic waves, the periodic pile system may also provide periodic arrays of piles in the soil, or periodic piles, surrounding the underground structure. The periodic array of piles may be vertically inserted into the soil surrounding the underground structure. For the periodic piles, the periodic array of piles may be arrays of 2D periodic-based materials or unit-cells that are arranged to block lateral seismic waves.

In some embodiments, the periodic piles may surround the structure, such as from all sides or the like. The periodic piles functions in a similar manner as the periodic foundation, which blocks incoming waves falling in certain frequency ranges. Properly designed periodic piles will be able to significantly reduce incoming seismic waves. The combination of periodic piles and periodic foundation for the underground structure will result in a total isolation for the underground structure. This total isolation shall be of interest for important underground facilities, such as underground nuclear power plants and structures with basements. Moreover, the total isolation will guarantee fewer compromises to the entire emergency response system. The system, which can be made of concrete piles buried in the soil, has a low production cost. Further, the finite element simulation discussed below show that the device works as expected.

Combining the periodic piles at the surrounding soil and the periodic foundation underneath the underground structure may result in a total isolation of the structure from earthquake wave energy as the periodic piles and periodic foundation prevent energy from passing through. Hence, the system assures seismic protection to the underground structure. Moreover, this total isolation may also be of interest for structures housing highly vibration-sensitive equipment such as research laboratories, medical facilities with sensitive imaging equipment, high-precision facilities specializing in the fabrication of electronic components, or the like.

Additionally, the manufacturing process of the periodic pile system is easy, and the raw materials are widely used in construction. The piles can be made of reinforced concrete material and buried in the soil. Therefore, the isolation method is both simple and economical.

Theoretical frequency band gaps of periodic piles can be obtained by employing the Bloch-Floquet theorem assuming plane strain 2D periodic material of concrete piles on soil matrix. Subsequently, a parametric study was conducted to investigate the effect of the arrangement and the size of piles on frequency band gap. Finally, the above concepts were applied to an underground small modular reactor building. The finite element studies showed great reduction in structural response to harmonic waves. The periodic pile system has potential to have an enormous impact on economic savings and structural safety for civil structures.

In some nonlimiting embodiments, the periodic pile system may be used for SMRs to greatly reduce the damaging effects of seismic waves on the superstructure and components, in both the horizontal and vertical directions. Further, this may be accomplished without the large relative displacement of other seismic isolation systems.

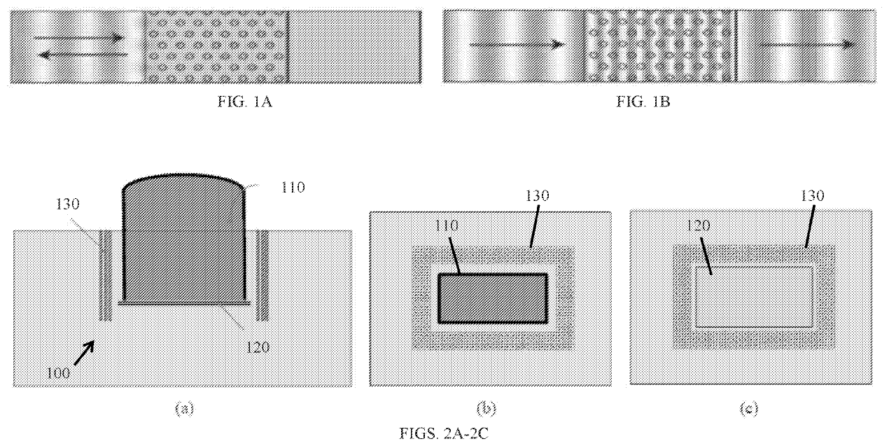

The application of periodic material-based seismic isolation systems, or periodic-material foundations (PFs) and periodic piles, have the potential to mitigate the potential seismic damages to underground structures, such as SMR buildings. The basic property of periodic material is their inherent ability to block certain frequencies in the seismic waves from being transmitted through the periodic material to the underground structure. With a proper design, the isolation system with periodic material is able to block the strong component of earthquake motion, thereby mitigating damage to the superstructure. Therefore, the proper design of the periodic material can effectively block the transmission of seismic waves over a selected range of frequencies (called the frequency band gaps). FIGS. 1a and 1b show the characteristics of frequency band gaps in a theoretical periodic material. The wave shown in FIG. 1a cannot propagate through the periodic material when the frequency of the wave falls within the range of the frequency band gaps of the material. The wave shown in FIG. 1b, however, can propagate into and through the periodic material since the frequency of the wave is outside of the range of the frequency band gaps of the material.

An isolation system made of period material can be properly designed and constructed so that it possesses frequency band gaps that will block damaging energy inputs with the associated frequencies. In some embodiments, these gaps are designed to include the natural frequencies of the underground structure (e.g. SMR building) and the acceleration amplification region of the design response spectrum. As mentioned above, unlike the traditional base isolation systems, the periodic-material isolation system does not introduce large relative displacements between the foundation and the supported structure that would occur during the seismic event. In addition, the periodic-material isolation system can effectively reduce the structural vibration in the vertical direction, whereas traditional base isolation systems are not typically able to provide such benefits. Using the periodic material, the proof-of-concept for periodic material foundations has been confirmed in small scale tests recently completed.

Current proven seismic isolation designs for building and bridge structures employ either high damping rubber bearings, lead-rubber bearings, or friction pendulum bearings. These systems can only provide vibration reduction in the horizontal direction, and relatively large displacements result between the building and the foundation result from the seismic event. These large displacements must be accommodated in the design of superstructure, such as with a gap (a.k.a. “moat”) between the isolated structure and the surrounding non-isolated structures to avoid hammering of the building or structures. Thus, any piping, utility lines, or communication systems conduits which link the isolated structure to the surrounding non-isolated buildings, systems and structures, must be designed to accommodate these large displacements. Since these displacements can be as great as 2-3 feet, this can present a difficult design challenge, especially for any large diameter piping running across the moat.

A seismic isolation system, which has no or minimum relative displacements during or after earthquakes, and can also reduce the seismic vibration in both horizontal and vertical directions, is a very attractive design option.

Building upon recent advances in solid-state physics research, and periodic-material foundations discussed in U.S. Pat. No. 9,139,972, an innovative seismic isolation system using periodic materials for underground structures is proposed. As noted in U.S. Pat. No. 9,139,972, seismic energy may be obstructed or changed when it reaches the periodic materials of periodic foundation resulting in total isolation of the structure. Further, the periodic materials may be one-dimensional (1D), two-dimensional (2D), or three-dimensional (3D). However, as noted previously, the periodic foundation of U.S. Pat. No. 9,139,972 is not suitable for underground structures.

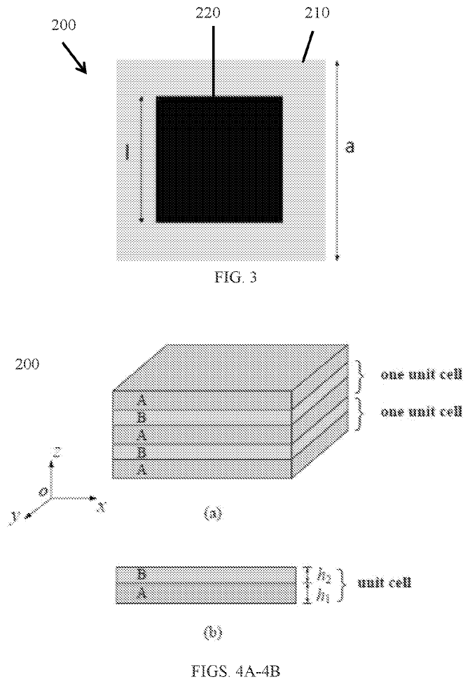

FIGS. 2A-2C show a cross section, top view, and bottom view of a seismic isolation system 100 for an underground structure 110, such as a SMR building. As shown, at least a portion of the underground structure 110 is below ground. The seismic isolation system 100 is periodic material-based. The foundation may be a periodic foundation 120, such as discussed previously in U.S. Pat. No. 9,139,972. The periodic foundation 120 may be place below a base of the underground structure, such as by forming the periodic foundation prior to formation of the underground structure on top of the foundation. The periodic foundation 120 may be layers of periodic materials arranged horizontally to support the SMR structure 110 or a layered periodic-material foundation (PF). The layered PF 120 may comprise 1D, 2D, or 3D periodic materials as discussed in U.S. Pat. No. 9,139,972. In the nonlimiting example shown, the PF 120 is illustrated as layers of 1D periodic materials or alternating layers of a first material and a second material (e.g. rubber and concrete) that are suitable for isolating the underground structure 110 from the vertical component of seismic waves.

It should be apparent that the ground or soil surrounding the portion of the structure 110 that is below ground results in the below ground portion of the structure being exposed to potential seismic waves. While the bottom of the structure may be isolated from seismic waves due to the PF 120, the sides of the below ground portion of the structure 110 are exposed to the surrounding soil and potential seismic waves approaching laterally. The seismic isolation system 100 addresses this by providing periodic piles 130 (or unit cells) buried below ground or in the soil that surround the underground structure 120. As a nonlimiting example, the periodic piles 130 form a perimeter around or completely surround the underground structure 120 without any gaps between the periodic piles 130. It should be noted that in contrast to the U.S. Pat. No. 9,139,972 use concrete as a matrix material, periodic piles 130 may comprise any suitable matrix material, such as, but not limited to, the surrounding soil. In the embodiment shown, the base of the structure 110 is rectangular, and the periodic piles 130 are in a rectangular arrangement that completely surrounds the structure. As the base of the structure 110 may be any suitable shape in other embodiments, the periodic piles 130 may be arranged in any suitable manner that surrounds or completely surrounds the base of the structure, such as a rectangular, square, circular, or oval arrangement. The periodic piles 130 are made of 2D periodic materials that are vertically arranged layers or piles buried in soil medium setup that completely surround the structure 110 to block the lateral component of seismic waves. In some embodiments, each layer may comprise a vertical array of one or more periodic unit cells. The periodic piles 130 may span from a top level of surrounding soil to at least a depth of the base of the underground structure 110 or a depth of the PF 120. In some embodiments, the depth of periodic piles 130 may extend slightly below the underground structure 110 or the PF 120.

As illustrated in FIGS. 2A-2C, the seismic isolation system 100 comprises an array of periodic unit cells 200, shown in further detail in FIG. 3, which are a repeating pattern of a two-dimensional unit. Each unit cell 200 comprises the matrix material 210 and one or more piles or pile materials 220. A nonlimiting example of a 2D array of periodic materials is shown from a top view in FIG. 3. The 2D array of periodic materials is referred to as 2D because it obstructs energy propagation in two directions e.g. x and y, x and z or y and z. As shown in FIG. 3, the 2D array may comprise a matrix material 210 that comprises the majority of the array or vertical layer. The matrix material 210 may be any suitable material. It should be noted that in contrast to the periodic foundations, the periodic piles do not support the weight of the structure, thereby allowing more flexibility in the matrix material 210. In contrast to the U.S. Pat. No. 9,139,972 use of concrete matrix material, a nonlimiting example of a suitable matrix material 210 may be soil. The 2D array may also comprise one or more pile materials 220, such as a core material with or without coating material. The pile materials 220 may be selected from any materials that are suitable for the frequencies to be isolated. It shall be apparent to one of ordinary skill in the art that materials selected for the pile materials may depend on the desired frequency band gaps and are selected in accordance with the desired engineering design. In some embodiments, the core material may be a strong material in comparison to the matrix material 210, such as concrete or the like. In some embodiments, the optional coating material may be an elastic or soft material, such as rubber or the like. As a nonlimiting example, the pile material 220 may be concrete as it has sufficient frequency band gaps to filter most seismic waves, and the matrix material 210 may be soil. The periodic pile materials 220 and surrounding matrix material 210 may form an array of periodic unit cells 200.

A nonlimiting example of a periodic unit cell 200 is shown in FIG. 3 from a cross sectional view or top view. It shall be apparent to one of ordinary skill in the art that the periodic unit cell 200 is a three dimensional object or a rectangular cuboid in the nonlimiting example shown. In other words, a single periodic unit cell 200 may comprise the entirety of the pile material 220 (e.g. core material and optionally a coating material) from the top of the soil to the bottommost depth, as well as the surrounding matrix material 210. The matrix material 210 of the unit cell 200 surrounds the one or more pile materials 220, such as the core or coating materials discussed above. As a nonlimiting example, when viewed from the top the pile materials 220 may have a square shape with sides having a predetermined length (l). The pile materials 220 may be solid or non-hollow. Referring to the nonlimiting example shown in FIG. 2A, the pile materials 220 span the entire depth or height of the unit cells. Further, from the views shown in FIGS. 2B-2C, the rectangular cuboid unit cells 130 are arranged in a rectangular pattern to completely surround the structure 110

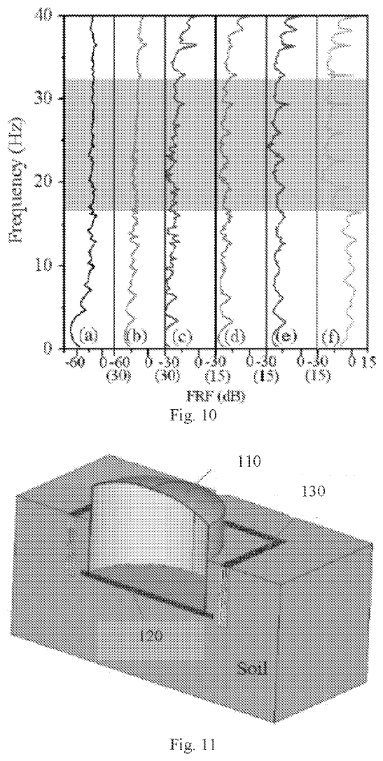

In other embodiments, the pile 220 may be any other suitable shape. As a nonlimiting example, the core material may be shaped as a right circular cylinder and the coating material shaped as a tubular cylinder. It shall be apparent to one of ordinary skill in the art that the core material and coating materials, or pile materials 220 collectively, in FIG. 3 may be any suitable three-dimensional shape, including, but not limited to, a cuboid, cylinder, right circular cylinder, elliptic cylinder, parabolic cylinder hyperbolic cylinder, tubular versions of such shapes for coating materials when present, or the like. FIG. 3 illustrates a nonlimiting example of a unit cell 200 with matrix material provided as a cuboid with equal side lengths (a). FIGS. 2A-2C and 3 orient unit cells 200 so the piles 220 are vertical or spans the entire height/depth of the unit cell. FIGS. 9A-9B also show a top and side view of a nonlimiting example of such an arrangement.

Referring back to FIG. 2A, the periodic piles 130 or the vertical layers of periodic materials extend from the top level of the soil or ground down to at least the depth of the bottom of the underground structure 110 or layered PFs 120. In some embodiments, the vertical layers of the periodic piles 130 extend to a depth slightly below the bottom of the underground structure 110 or layered PFs 120. Utilizing multiple layers of periodic materials for the PF 120 or periodic piles 130 may improve reflection of waves in the frequency band gap. In some embodiments, the PF 120 or period piles may be selected to isolate or reflect waves ranging from 0 to 50 Hz. In some embodiments, layers of the periodic piles 130 or PF 120 may be tuned to provide slightly overlapping isolated frequency band gaps, which may be utilized to widen the overall isolated frequency band gap of the periodic piles. For example, a first layer or group of layers for the periodic piles 130 may be tuned for isolating or reflecting a first frequency band gap (e.g. 0-10 Hz); a second layer or second group of layers may be tuned for isolation or reflecting a second frequency band gap (e.g. 10-20 Hz), and further layers may be tuned for isolating or reflecting other frequency band gap(s). In some embodiments, these first, second, and other isolated frequency band gap(s) may overlap slightly, e.g. the first isolated frequency band gap may be 0-10 Hz and the second may be 8-18 Hz. In some embodiments, the periodic piles 130 or PF 120 may be tuned to isolate or reflect a resonant frequency of the underground structure 110. In some embodiments, the periodic piles 130 may provide two or more vertical layers and/or the periodic foundation 120 may provide two or more horizontal layers of unit cells. In the nonlimiting example shown, the periodic piles 130 are illustrated as 3 vertical layers of arrays of 2D periodic materials. However, other embodiments may provide any number of vertical layers or vertical arrays of periodic materials, and/or any number of horizontal layers of unit cells. In some embodiments, a small gap between the periodic piles 130 and the structure 110 may be provided so the piles do not directly contact the superstructure. In the embodiment shown, the periodic piles 130 are arranged in a rectangular shape when viewed from the top or bottom views. As such, the periodic piles 130 are arranged with four sides to completely surround the rectangular shape of the underground structure 110. Because the shape of a base of the underground structures 110 may vary, other embodiments of periodic piles 130 may be arranged in any shape that conforms to the underground structure. Nonlimiting examples of the shape of a base of the structure may include square, circular, ovular, or other arrangements. Like the arrangements for structures with a square or rectangular base, for circular or oval bases, the array of unit cells or periodic piles are arranged to form a perimeter around or completely surround the structure without any gaps between the edges of the unit cells closest to the structure. As a nonlimiting example, an array of rectangular cuboid unit cells may be arranged in a circle or oval arrangement where the two corners of each unit cell touch the immediately adjacent unit cells, thereby allowing the edge surfaces of the unit cells closest to the structure to form a perimeter around the structure that completely surrounds the structure without gaps.

### Experimental Example

The following examples are included to demonstrate particular aspects of the present disclosure. It should be appreciated by those of ordinary skill in the art that the methods described in the examples that follow merely represent illustrative embodiments of the disclosure. Those of ordinary skill in the art should, in light of the present disclosure, appreciate that many changes can be made in the specific embodiments described and still obtain a like or similar result without departing from the spirit and scope of the present disclosure.

A nonlimiting example of a design for a periodic isolation system of an SMR building is shown in FIGS. 2A-2C. Layered PFs 120 are composed of 1D periodic materials, particularly alternating concrete and rubber layers arranged horizontally. Periodic arrays of 2D periodic materials are arranged as vertical layers in soil to provide the periodic piles 130.

To demonstrate how the mechanism of frequency band gaps works, two alternating layers of different isotropic materials are arranged as shown in FIG. 4A. For the coordinate system specified, any two adjacent layers in the body comprise a periodic unit cell, and this periodic unit cell is completely invariant under a lattice translation along the z-direction. Each layer is infinitely extended in the plane. The thickness of the layer A and the layer B of a unit cell is h₁ and h₂, respectively. The periodicity of the layered periodic foundation and displacement makes it possible to investigate the frequency band gaps by studying one periodic unit, or unit cell as show in FIG. 4B.

Let v,w be displacements in y and z direction, respectively. Consider an elastic wave with propagation along z. The equation of motion in each layer is

$$\frac{{\partial }^{2} {u}_{i}}{\partial {t}^{2}} = {C}_{i}^{2} \frac{{\partial }^{2} {u}_{i}}{\partial {z}_{i}^{2}} \qquad ( 1 )$$

where u=w and C=Cₚ=\sqrt{(λ+2μ)/ρ} for longitudinal wave (P wave), or u=v and C=Cₜ=\sqrt{μ/ρ} for transverse wave (S wave). The coefficients λ and μ are Lame's elastic constants, and ρ is density. The index i=1, 2 indicates layers A and B, respectively. For the free vibration analysis, a plane wave form solution to Eq. (1) is assumed which is given by

uᵢ(zᵢ,t)=Ue^{i(k-z}^{ᵢ}^{-ωt)}=uᵢ(zᵢ)e^{iωt} (2)

where k is the wave number and ω the angular frequency. Substituting Eq. (2) into Eq. (1) yields

$${C}_{i}^{2} \frac{{\partial }^{2} {u}_{i} ( {z}_{i} )}{\partial {z}_{i}^{2}} + {ω}^{2} {u}_{i} ( {z}_{i} ) = 0 \qquad ( 3 )$$

The general solution of this equation is found as follows:

uᵢ(zᵢ)=Aᵢ sin(ωzᵢ/Cᵢ)+Bᵢ cos(ωzᵢ/Cᵢ) (4)

There are four unknown constants A₁, A₂, B₁ and B₂ which are determined by boundary and continuity conditions. For the case of transverse waves, the normal stress σ_{z} in each layer is zero which automatically satisfies the continuous condition at the interface. The stress continuity across the interface requires that the shear stress τ is continuous. Therefore, the continuity of displacement and stress at the interface z₂=0 (or z₁=h₁) are

u₁(h₁)=u₂(0), τ₁(h₁)=τ₂(0) (5)

Due to the periodicity of the layered structure in the z direction, according to the Block theorem, the displacement and stress must satisfy the following periodic boundary conditions

u₁(0)e^{k·h}=u₂(h₂), τ₁(0)e^{k·h}=τ₂(2) (6)

where h₁=h₁+h₂. The shear stress can be expressed as

τᵢ(zᵢ)=μᵢôuᵢ/ôzᵢ=μᵢω[Aᵢ cos(ωzᵢ/Cₜᵢ)−Bᵢ sin(ωzᵢ/Cₜᵢ)]/Cₜᵢ (7)

Substituting Eqs. (4) and (7) into Eqs. (5) and (6), we have

$$[ \begin{matrix}sin ( ω {h}_{1} / {C}_{t 1} ) & cos ( ω {h}_{1} / {C}_{t 1} ) & 0 & - 1 \\ {μ}_{1} {C}_{t 2} cos ( ω {h}_{1} / {C}_{t 1} ) & - {μ}_{1} {C}_{t 2} sin ( ω {h}_{1} / {C}_{t 1} ) & - {μ}_{2} {C}_{t 1} & 0 \\ 0 & {e}^{ik \cdot h} & - sin ( ω {h}_{2} / {C}_{t 2} ) & - cos ( ω {h}_{2} / {C}_{t 2} ) \\ {μ}_{1} {C}_{t 2} \cdot {e}^{ik \cdot h} & 0 & - {μ}_{2} {C}_{t 1} cos ( ω {h}_{2} / {C}_{t 2} ) & {μ}_{2} {C}_{t 1} sin ( ω {h}_{2} / {C}_{t 2} )\end{matrix} ] [ \begin{matrix}{A}_{1} \\ {B}_{1} \\ {A}_{2} \\ {B}_{2}\end{matrix} ] = 0 \qquad ( 8 )$$

A necessary and sufficient condition for the existence of a non-trivial solution to Eq. (8) is that the determinant of the coefficient matrix is zero. After the expanding the determinant, one obtains the dispersion relation for co as a function of k which is given by

$$cos ( k \cdot h ) = cos ( \frac{ω {h}_{1}}{{C}_{t 1}} ) cos ( \frac{ω {h}_{2}}{{C}_{t 2}} ) - \frac{1}{2} ( \frac{{ρ}_{1} {C}_{t 1}}{{ρ}_{2} {C}_{t 2}} + \frac{{ρ}_{2} {C}_{t 2}}{{ρ}_{1} {C}_{t 1}} ) sin ( \frac{ω {h}_{1}}{{C}_{t 1}} ) sin ( \frac{ω {h}_{2}}{{C}_{t 2}} ) \qquad ( 9 )$$

Because |cos(k·h)|≤1, Eq. (9) is satisfied only when the value of the right-hand side is between −1 and +1. The band gaps are the values of ω and k that are the solutions to Eq. (9), but fall outside the range of −1 to 1. Following the same procedure, one can derive a similar result for the case of longitudinal waves. If materials A and B are the same, i.e. Cₜ₁=Cₜ₂=Cₜ and ρ₁=ρ₂, we get the dispersion relation for a homogenous material as cos(k·h)=cos(ωh/Cₜ) where ω=kCₜ.

For any value of k, we can find a frequency ω to satisfy this relation. This is why there are no band gaps in a homogenous material. In general, the dispersion equation that defines the relation between ω and k is numerically solved to find values of ω and k. Though the wave number k is unrestricted, it is only necessary to consider k limited to the first Brillouin zone, i.e., k∈[−π/h, π/h]. In fact, if we choose a wave number k₀ different from the original k in the first Brillouin zone by a reciprocal lattice vector, for example k₀=k+2nπ/h where n is an integer, we may obtain the same set of equations because of the exponential e^{k}^{₀}^{h}=e^{k·h} in Eq. (8). As an example, two common materials, concrete and rubber, are used to fabricate the periodic foundation. The thickness of both layers are h₁=h₂=0.2 m. FIGS. 5A-5B present the variations of frequencies ω for both transverse wave and longitudinal wave as a function of the reduced wave number k in the first Brillouin zone. The introduction of inhomogeneities implies the opening of a gap at the Brillouin zone boundary k=−π/h or k=π/h. The curves are related to real wave numbers and the frequency band gaps are related to complex wave numbers (evanescent wave), which are not calculated and don't appear in FIGS. 5A-5B. For transverse wave, the first two band gaps are: 6.6 Hz-15.0 Hz and 17.8 Hz-30.0 Hz. For longitudinal modes, the first band gap starts from 25.0 Hz to 57.2 Hz and the second band gap is 67.9 Hz-114.3 Hz. Notice that the rubber layers used in this design will not produce a large horizontal displacement as is the case for the rubber layers in the conventional laminated elastomeric seismic isolator. This is because the motion is reflected from the periodic material. In the preliminary shake table test discussed below, the results show that the horizontal displacement at the rubber layer is quite small.

Experimental Results of Layered PFs:

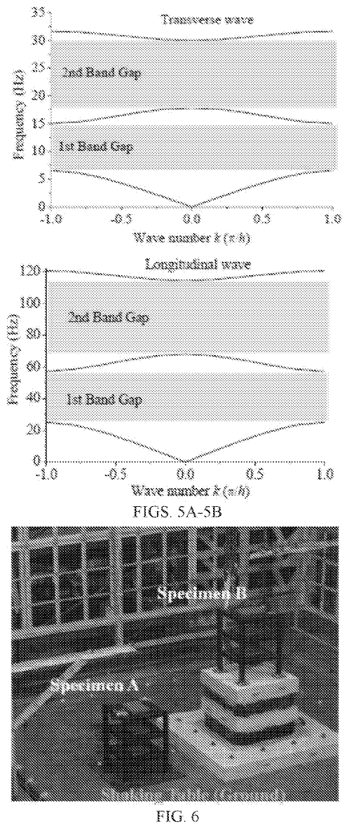

Based on the theoretical study of the frequency band gaps, an experimental study was conducted to investigate the feasibility of a 1D periodic foundation. A small-scale model frame on a periodic foundation was designed, fabricated, and tested using the shake table facility at the laboratory of the international collaborator. As shown in FIG. 6, specimen A is a steel frame fixed on the shake table. Specimen B is a steel frame of the same design as specimen A, but is fixed on a 1D periodic foundation. The concrete layers and rubber layers are bonded together by polyurethane (PU) glue for which the anti-pull strength is larger than 20.89 ksf, and the tear strength is larger than 125.31 ksf. The 1975 Oroville seismogram obtained from the PEER Ground Database was used as the input motion for the shake table tests. The nominal peak ground acceleration (PGA) is scaled to 0.418 g. FIG. 7 shows the acceleration time histories of the top of the frames. For the frame on a periodic foundation, the peak horizontal acceleration is reduced by as much as 50% as compared to that of the frame without a periodic foundation. These preliminary test results are promising and support the feasibility of periodic material-based seismic isolation system for underground SMR buildings.

Frequency Band Gaps of Periodic Piles:

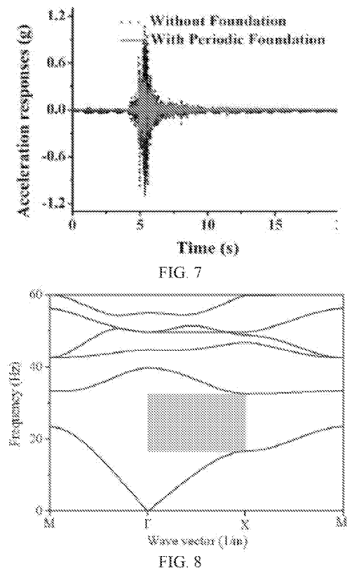

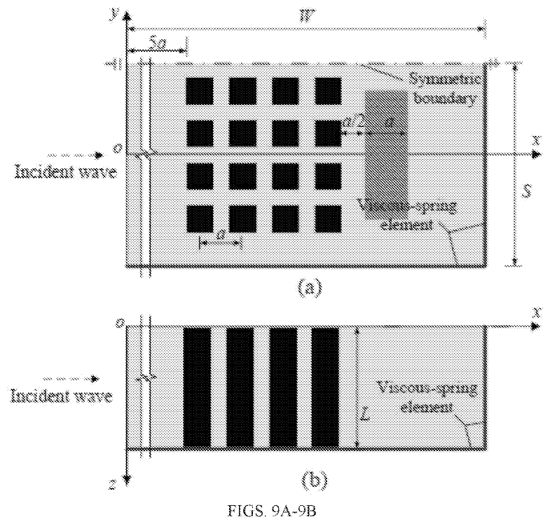

In a nonlimiting experimental example, the unit cells of the periodic piles 130 in FIGS. 2A-2C may comprise soil as the matrix material and concrete pile material. Using the finite element method, frequency band gaps can be obtained. By taking the side length of the typical unit cell or periodic constant as a=2 m and that of the side length or width of the core as l=1.2 m (e.g. FIG. 3), FIG. 8 shows the dispersion curves of out-of-plane waves in the periodic piles, where the shaded area is the directional band gap/directional attenuation zone (DAZ). Elastic waves propagating in periodic pile barriers with a finite number of unit cells (see FIGS. 9A-9B) are simulated to verify the frequency band gaps. When the side length of the core is sufficiently large, the 3D model can be reduced to a 2D plain strain model. To demonstrate the wave attenuation in periodic pile barriers, the frequency response function (FRF) is defined as 20 log(δ₀/δᵢ) where δ₀ is the amplitude of displacement of the reference points and δᵢ (i=x,y,z) is the amplitude of input excitation. The shaded areas in FIG. 10 are the DAZ or the theoretical frequency band gap obtained by the 2D periodic structure theory. Great vibration reduction can be found for all the 3D and 2D models when the excitation frequency is inside the DAZ. Moreover, as the pile length increases, it can be seen that the 3D solutions converge to the 2D solution.

The feasibility of using a periodic pile system to block seismic waves has been verified. For underground structures, such as SMR building applications, several key factors should be taken into account:

1. Seismic design spectra are concerned with low fundamental frequencies ranging from frequencies of 0 to 50 Hz, which corresponds well to the characteristic frequency of underground SMR building. It is critical, therefore, to achieve a frequency band gap with a lower-bound frequency close to 0 Hz and an upper-bound frequency at 50 Hz.

2. In some embodiments, the frequency band gap may be chosen to match the natural frequencies of the underground SMR building, as opposed to matching the frequency with the strong energy of the excitation. However, other variations may be possible upon further study of effectiveness.

3. The main frequencies of the external vibrations may vary with the vibration direction. Embodiments or arrangements of the periodic isolation systems may vary to serve as a multi-direction isolation systems.

4. The overall capacity of the periodic isolation system must also be able to resist normal service loads, including parameters such as bearing capacity and deflections or differential movements. The periodic piles may be of very large-size lattice constants. The desire for proper scale and economy for the periodic isolation systems results in the preference to use materials that will achieve the desired frequency band gaps, yet be commonly used materials in civil infrastructure applications and be familiar to both designers and contractors.

Dynamic Properties of Underground SMR Building:

As mentioned above, the frequency band gaps of the periodic isolation system are expected to match the main frequency region of the seismic waves and to cover the characteristic frequencies of the underground SMR building. The main frequency region of the seismic design spectra is between 0 Hz and 50 Hz in the seismic design of underground SMR buildings. However, the principal resonance frequency of the underground SMR building varies and mainly dependent on its structural configuration. As an analysis for the design of seismic isolation system, it is of importance and necessity to determine the characteristic frequencies of the underground structure, such as an SMR building, so the system can be catered to the particular underground structure. In some embodiments, the resonant frequency of the under can be calculated, and as discussed previously, the design of the periodic foundation and periodic piles of the seismic isolation system can be selected to reflect the determined resonant frequency of the underground structure.

Determine Frequency Band Gaps of the Periodic Isolation System:

Finding the low and wide frequency band gaps to cover the dominant frequency range of the seismic design spectra or the characteristic frequencies of the underground SMR building is then the a main challenge to determining the actual design. In previous investigations, the theoretical studies on layered periodic foundations and periodic piles have been conducted to determine the effect of both the geometrical and material parameters on the frequency band gaps. However, the side length of the periodic piles may vary from these experiments. In some embodiments, the frequency band gaps of the periodic isolation system may have small-size lattice constants. As nonlimiting example, concrete and rubber may be used to fabricate the layered periodic foundations, and concrete and steel may be used for the periodic piles.

Dynamic Analysis of Underground SMR Building with Periodic Isolation System:

the analytical results obtained are based on the assumption that the layered periodic foundation and the periodic piles are infinite in the periodicity directions. However, both the periodic foundations and the periodic piles are finite in practical application. As shown in FIG. 11, an ANSYS model is built for the underground SMR building 110 with periodic supports. The layered periodic foundation 120 comprises three concrete layers and two rubber layers. The underground SMR building 110 is fixed on the layered periodic foundation 120 and surrounded by the periodic piles 130. The periodic piles 130 comprise three vertical layers of 2D periodic materials, where the unit cells comprise soil matrix material and concrete pile material. Scanning frequency analysis will be conducted first to predict the attenuation zones of the periodic isolation system, and then a time history analysis will be performed under both harmonic and seismic waves. Based on the finite element analysis, candidates for the most appropriate periodic isolation system will be designed.

Scanning frequency (Study I), harmonic excitation (Study II), and seismic loading (Study III) may be performed to examine the isolation characters of the periodic isolation systems. Details on the studies are as follows:

Study I: Scanning Frequency Study:

A horizontal harmonic ground motion with amplitude δᵢ (i=x,y,z) is applied to the left boundary of the above mentioned finite element model. The other two DOFs are fixed when the amplitude δᵢ is applied in the i direction. The frequency of the excitation may be increased from 0 to 50 Hz with an interval Δf=0.01 Hz. Displacement responses of the various reference points may be collected. Scanning frequency studies may be used to obtain the FRFs of the reference points with the periodic isolation system and without the periodic isolation system. Note that if the input displacement and the output displacement are the same then the FRF will be 0. Therefore, a negative number in FRF indicates a very effective isolation by the periodic isolation system.

Study II: Harmonic Excitation Study:

The harmonic waves with an amplitude of 0.1 inch may be employed with several excitation frequencies inside and outside the design frequency band gaps. The results of a harmonic excitation study may indicate the dynamic properties of the periodic isolation system subjected to excitations inside and outside the design frequency band gaps, and may verify the isolation effectiveness of the periodic isolation system compared to the conventional isolation foundation when subjected to excitations inside the design frequency band gaps.

Study III: Seismic Response Study:

Different seismic waves may be employed as the input motions. A seismic loading study may present a clear view of the vibration isolation when periodic isolation systems are used. Time history of acceleration and displacement responses of the reference points may be collected. The performance of the periodic isolation system, i.e., vibration isolation, may be evaluated, and the results may lead to a guideline for the design of periodic isolation system.

Design of Periodic Isolation System:

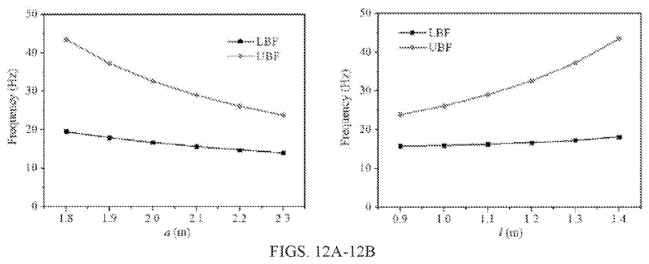

In a preliminary analysis, both the lower bound frequency (LBF) and upper bound frequency (UBF) of the first band gaps in unit cells of the periodic piles decrease with the increase of the periodic constant (a) when the filling ratio is fixed, as shown in FIG. 12A. Moreover, both the LBF and UBF increase consistently with the increasing side length (l) of unit cell core of the piles, as shown in FIG. 12B. Further analysis may allow additional factors to be determined, particularly factors that influence both low and wide frequency band gaps that are desired for the seismic isolation system for underground SMR buildings.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A method for seismic isolation of an underground structure, the method comprising:
placing a periodic foundation (PF) below a base of the underground structure, wherein the periodic foundation isolates the underground structure from seismic waves approaching from below the periodic foundation; and
surrounding a below ground portion of the underground structure with periodic piles, wherein the periodic piles isolate the underground structure from a lateral component of the seismic waves, and the periodic piles spans from a top level of surrounding soil to at least a depth of the base of the underground structure or a depth of the PF.

2. The method of claim 1, wherein the PF comprises one-dimensional (1D) periodic materials comprising alternating layers of a first material and a second material.

3. The method of claim 1, wherein the periodic piles comprise two-dimensional (2D) periodic materials comprising a matrix material and at least one pile material, and the pile material is surrounded by the matrix material.

4. The method of claim 3, wherein each unit cell of the 2D periodic materials comprises the at least one pile material formed as a non-hollow cylinder or cuboid spanning a height of the unit cell, and the matrix material surrounding the at least one pile material.

5. The method of claim 4, wherein the at least one pile material is concrete, and the matrix material is soil.

6. The method of claim 1, wherein the depth of the periodic piles extends below a bottom of the underground structure or the PF.

7. The method of claim 1, wherein the periodic piles completely surround the underground structure.

8. The method of claim 7, wherein the base of the underground structure is square or rectangular, unit cells of the periodic piles are rectangular cuboids, and the periodic piles are arranged in a square or rectangular arrangement.

9. The method of claim 7, the base of the underground structure is circular or oval-shaped, and the periodic piles are arranged in a circular or oval arrangement.

10. The method of claim 1, wherein the periodic piles comprise two or more vertical layers of unit cells.

11. The method of claim 1, wherein the periodic piles are tuned to isolate frequencies of 0 to 50 Hz.

12. The method of claim 11, wherein vertical layers of the periodic piles are tuned to isolate overlapping frequency band gaps.

13. The method of claim 1, wherein the periodic piles are tuned to reflect a resonant frequency of the underground structure.

14. A system for seismic isolation of an underground structure comprising:
a periodic foundation (PF) positioned below a base of the underground structure, wherein the periodic foundation isolates the underground structure from seismic waves approaching from below the periodic foundation; and
periodic piles surrounding a below ground portion of the underground structure, wherein the periodic piles isolate the underground structure from a lateral component of the seismic waves, and the periodic piles spans from a top level of surrounding soil to at least a depth of the base of the underground structure or a depth of the PF.

15. The system of claim 14, wherein the PF comprises one-dimensional (1D) periodic materials comprising alternating layers of a first material and a second material.

16. The system of claim 14, wherein the periodic piles comprise two-dimensional (2D) periodic materials comprising a matric material and at least one pile material, and the pile material is surrounded by the matrix material.

17. The system of claim 16, wherein each unit cell of the 2D periodic materials comprises the at least one pile material formed as a non-hollow cylinder or a non-hollow cuboid spanning a height of the unit cell, and the matrix material surrounding the at least one additional materials.

18. The system of claim 17, wherein the at least one pile material is concrete, and the matrix material is soil.

19. The system of claim 14, wherein the depth of the periodic piles extends below a bottom of the underground structure or the PF.

20. The system of claim 14, wherein the periodic piles completely surround the underground structure.

21. The system of claim 20, wherein the base of the underground structure is square or rectangular, unit cells of the 2D periodic materials are rectangular cuboids, and the periodic piles are arranged in a square or rectangular arrangement.

22. The system of claim 20, wherein the base of the underground structure is circular or oval-shaped, and the periodic piles are arranged in a circular or oval arrangement.

23. The system of claim 14, wherein the periodic piles comprise two or more vertical layers of unit cells.

24. The system of claim 14, wherein the periodic piles are tuned to isolate frequencies of 0 to 50 Hz.

25. The system of claim 24, wherein vertical layers of the periodic piles are tuned to isolate overlapping frequency band gaps.

26. The system of claim 14, wherein the periodic piles are tuned to reflect a resonant frequency of the underground structure.
